(19) United States
(12) Patent Application Publication
(10) Pub. No.: US 2006/0235986 A1
(43) Pub. Date: Oct. 19, 2006

(54) Web service processing apparatus and method

(75) Inventor: Joo-hyun Kim, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/403,907

(22) Filed: Apr. 14, 2006

(30) Foreign Application Priority Data
Apr. 15, 2005 (KR) 10-2005-0031621

(51) Int. Cl. G06F 15/16

(52) U.S. Cl. 709/229

(57) ABSTRACT

A web service processing apparatus and method web services can provide by combining web services. The web service processing apparatus includes a registration unit where a plurality of web services are compounded and registered through predetermined conditions, a storage unit where the registered web service lists are stored, and an execution unit where the web service selected among the stored web service lists is executed by referring to the conditions.

### CROSS-REFERENCE TO RELATED APPLICATION

This application is based on and claims priority from Korean Patent Application No. 10-2005-00031621 filed on Apr. 15, 2005 in the Korean Intellectual Property Office, the disclosure of which is incorporated herein in its entirety by reference.

### BACKGROUND OF THE INVENTION

1. Field of the Invention

The present invention relates to a web service processing apparatus, and more particularly, to a web service processing apparatus and method web services can provide by combining web services.

2. Description of the Related Art

The information society allows an individual to access the world in various ways. In other words, the Internet is rapidly becoming popular, and the world is becoming integrated into a single electronic culture. For example, a businessman can make an approval or receive a business report anywhere in the world, and a user can obtain information on any aspect of the world.

That is, one who wants to get specific information can swiftly obtain the information after connecting to the information-providing web site on the Internet by the web browser of a computer connected to the Internet rather than by going to a library or a book store.

Information Technology (IT) has progressed in two stages: first and second generations. In the first generation, management of the information was centralized in a main server, but this shifted to a component-based client/server system in the second generation. Recently, the main stream is a web-based open system, which is based on a web-site or a web application server (WAS). According to changes in the IT environment, the concept of “web service” has become popular. It is designed to allow a variety of unconnected web applications to communicate with each other, and transceive data over the web.

A large number of companies currently use web services in order to provide services to users, covering industrial environment to home network. Accordingly, more diverse web services have been provided, and a method for searching for a web service desired by a user is required.

For reference, a web service system comprises a hypertext transfer protocol (HTTP), a simple object access protocol (SOAP), an extensible markup language (XML), a web services description language (WSDL), and universal description, discovery and integration (UDDI Registry).

HTTP is commonly used for message exchange through a transmission control protocol/internet protocol (TCP/IP) network. SOAP is an XML-based protocol used to transmit a message to call a method in a distributed environment. XML functions to enable message transmission between applications. WSDL describes web service information. UDDI Registry has a service list provided by a service provider, and it is an XML-based registry technology allowing a search for a service requested by a service requester.

FIG. 1 illustrates a conventional web service processing system and a method of providing a service through the UDDI Registry.

As illustrated, the conventional web service processing system comprises a service provider 11 that provides web services, a UDDI 12 Registry in which the provided web services are registered, and a service requester 13 that requests a desired service by searching the registered web service.

The service requester 13 requests a desired web service from a service provider 11 by searching the web service list registered in the UDDI 12 Registry, and requesting that the service provider 11 provide the desired web service to the corresponding web device, based on the WSDL of the searched for web service. Since the WSDL of the searched web service includes information of the corresponding web service, such as a URL, the service requester 13 requests that the service provider 11 provide the web service through the URL included in the WSDL.

The UDDI 12 Registry includes a registration unit 12a to register web services provided by the service provider 11, a list storage unit 12b in which a list of registered web services is stored, and a search unit 12c by which the service requester 13 searches for a desired service based on the web service list stored in the list storage unit 12b.

The registration unit 12a and the search unit 12c provide the application program interface (API) designated by the UDDI Standard, which is detailed in Tables 1 and 2.

TABLE 1
API for Registering Web Service

| | |
|---|---|
| Save_business | Add Business Entity |
| Save_service | Add Business Service |
| Save_binding | Add Binding Template |
| Save_tModel | Add tModel |
| Delete_business | Delete Business Entity |
| Delete_service | Delete Business Service |
| Delete_binding | Delete Binding Template |
| Delete_tModel | Delete tModel |

TABLE 2
API for Searching for Web Service

| | |
|---|---|
| Find_business | Search for Outline of Business Entity |
| Find_service | Search for Outline of Business |
| | Service |
| Find_binding | Search for Outline of Business |
| | Template |
| Find_tModel | Search for Outline of tModel in Detail |
| Get_business Detail | Search for Business Entity in Detail |
| Get_service Detail | Search for Business Service in Detail |
| Get_bindingDetail | Search for Business Template in Detail |
| Get_tModelDetail | Search for tModel in Detail |

As illustrated in FIG. 2, the list storage unit 12b stores data of the web service list in a predetermined form according to the UDDI Standard. The web service list data is stored based on a classification criterion defined in the UDDI Standard. For reference, the classification criterion defined in the UDDI Standard is determined according to classification colors: a white page W indicates brief description such as a name, an address, a phone number of a company or an individual that provides services, the yellow page Y indicates services classified by the North American industrial classification system (NAICS), a classification system of products and web services (UNSPSC), and a green page G indicates technical information on a provider of web services provided by each company.

FIG. 3 illustrates operations of the conventional web service processing system.

As illustrated, a plurality of service providers 11 register web services provided thereby in the UDDI 12 Registry (S11). When the registration of the web services is completed, the service provider 13 searches the UDDI 12 Registry for a desired service (S12).

The UDDI 12 Registry informs the service requester 13 of the position of web service information corresponding to the service desired by the service requester 13. The web service information relates to a position of the corresponding web service information, and the position information indicates the corresponding position information within the searched results in the tModel of FIG. 4. In other words, the position information in FIG. 4 includes position information of a WSDL including the corresponding web service information.

The service requester 13 requests the WSDL of the corresponding web service from the service provider 11 through the web service information (S14), and the service provider 11 provides the WSDL (S15). The WSDL provided by the service provider 11 includes position information of the corresponding web service, as illustrated in FIG. 5.

Then, the service requester 13 browses for the corresponding web service through the provided WSDL (S16), and the result is provided to him/her (S17).

As the web service processing system described above cannot integrate or separate one or more web services, the service requester 13 needs to directly ascertain whether the WSDL for the corresponding web service is identical when web services having different interfaces are used, thereby causing an inconvenience.

Since the validity of the registered web service is not separately determined, when the service provider 11 registers a web service, an invalid web service may be used by the service requester 13.

Further, a predetermined web service may have several methods, and a concerned method in the web service cannot be searched for.

Korean Published Patent Application No. 2004-0097137 discloses automatically discovering web services querying a known UDDI Registry server containing a list of web services, identifying suitable web services from the list and automatically downloading at least one machine-readable description of a web service. However, this method is only directed to searching the web services registered in the UDDI Registry, and it cannot solve the above-mentioned problems.

### SUMMARY OF THE INVENTION

An aspect of the present invention provides a web service processing apparatus and method, capable of providing more various web services through integration or separation of web services.

Another aspect of the present invention provides a web service processing apparatus and method, capable of providing only valid web services by determining the validity of the web service.

These and other aspects, features and advantages of the present invention will become apparent to those skilled in the art upon review of the following description.

According to an aspect of the present invention, there is provided a web service processing apparatus, comprising a registration unit where a plurality of web services are compounded and registered through predetermined conditions, a storage unit where the registered web service lists are stored, and an execution unit where the web service selected among the stored web service lists is executed by referring to the conditions.

According to another aspect of the present invention, there is provided a web service processing method comprising the steps of compounding a plurality of web services through predetermined conditions, storing the lists of the compounded web services, and executing the web service selected among the stored web service lists by referring to the conditions.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 illustrates a general web service processing system;

FIG. 2 illustrates a data structure of a list of general web services;

FIG. 3 illustrates operations of the general web service processing system;

FIG. 4 illustrates information on the position of a general web service;

FIG. 5 illustrates information on a general web service;

FIG. 6 illustrates a web service processing system according to an exemplary embodiment of the present invention;

FIG. 7 illustrates a configuration of a registration unit according to an exemplary embodiment of the present invention;

FIG. 8 illustrates a configuration of the execution unit according to an exemplary embodiment of the present invention;

FIG. 9 illustrates a data structure of the web service according to an exemplary embodiment of the present invention;

FIG. 10 illustrates a web service registering method according to an exemplary embodiment of the present invention;

FIG. 11 illustrates a web service searching method according to an exemplary embodiment of the present invention;

FIG. 12 illustrates information on the position of web service information according to an exemplary embodiment of the present invention;

FIG. 13 illustrates a web service executing method according to an exemplary embodiment of the present invention;

FIG. 14 illustrates an environment of a company environment constructed according to an exemplary embodiment of the present invention;

FIG. 15 illustrates a first example of a home network environment according to an exemplary embodiment of the present invention; and

FIG. 16 illustrates a second example of a home network environment according to an exemplary embodiment of the present invention.

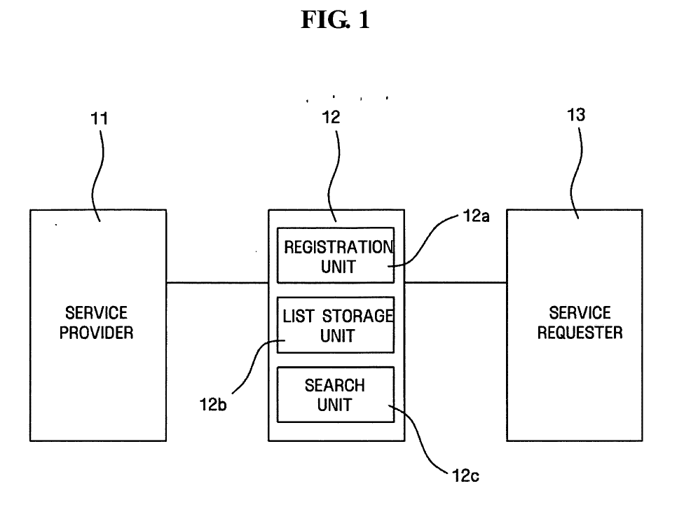

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to block diagrams or flowchart illustrations of a web service processing apparatus and system according to exemplary embodiments of the invention. It will be understood that each block of the flowchart illustrations, and combinations of blocks in the flowchart illustrations can be implemented by computer program instructions. These computer program instructions can be provided to a processor of a general purpose computer, special purpose computer, or other programmable data processing apparatus to produce a machine such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

An exemplary embodiment of the present invention will be described in detail with reference to the accompanying drawings.

FIG. 6 illustrates a web service processing system according to an exemplary embodiment of the present invention.

As illustrated, the web service processing system comprises a service provider 110 that provides web services, a web service processing apparatus 120 in which the service provider 110 registers the web services provided thereby, and a service requester 130 that searches for a desired service among the registered web services and requests the web service.

Each web service provided by the service provider 110 comprises at least one service. Each service included in the web services provided by a predetermined service provider is referred to as a “method” in this specification. Accordingly, each web service provided by a service provider 110 comprises at least one method.

The web service processing apparatus 120 comprises a registration unit 121 in which the service provider 110 registers the web services provided thereby, a determination unit 122 that determines whether the registered web services are valid, an execution unit 123 that executes a web service requested by the service requester 130 among the registered web services, a search unit 124 in which the service requester 130 can search for a desired service among the registered web services, and a storage unit 125 that stores a list of the registered web services.

The registration unit 121 selectively registers methods included in each web service provided by the service provider 110 through integration or separation. In other words, when a plurality of service providers 110 register web services to be provided to a web service processing apparatus 120, the registration unit 121 can register the methods included in the web services as a single web service by integrating them and registering them as separate web services.

For example, when the predetermined service provider provides a web service A including a method 1 and a method 2, and another service provider provides a web service B including a method 3 and a method 4, the registration unit 121 can register a virtual web service integrating the method 1 and the method 4 respectively included in the web service A and the web service B. Also, it can register separate virtual web services for the method 1 in the web service A and the method 4 in the web service B.

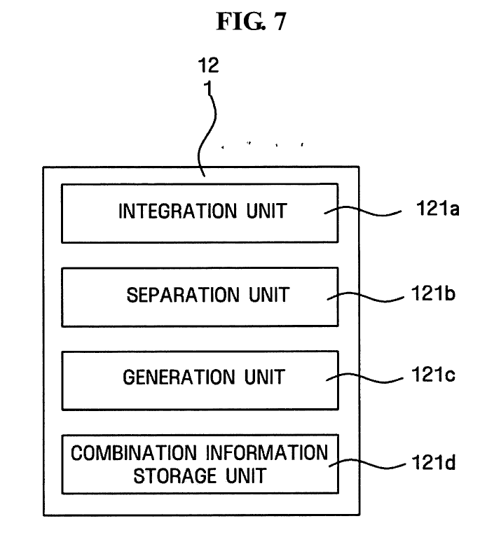

To provide new virtual web services for the web services provided by the service provider or providers 110 separately or in an integrated manner, the registration unit 121 may further comprise an integration unit 121a (FIG. 7) that integrates the methods included in the web service provided by each service provider, a separation unit 121b that separates the methods provided by each service provider, and a generation unit 121c that generates a new virtual web service integrating them or new separate virtual web services for them.

In addition to integration and separation, the registration unit 121 can create virtually integrated WSDLs or virtually separated WSDLs corresponding to the virtual web service or services created by the generation unit 121c by integrating or separating the WSDLs of the integrated or separated methods. As an example of the present invention, it will be described that the virtually integrated or separated WSDLs are generated by the integration unit 121a or separation unit 121b, and integration or separation of the WSDLs may be performed through a separate configuration.

In addition to the API described in Table 1, the API in Table 3 can be used for the integration and the separation of the methods through the integration unit 121a and the separation unit 121b.

TABLE 3
API for Integration/Separation of Method

| | |
|---|---|
| Save_Method | Add Description of Method |
| Delete_Method | Delete Description of Method |
| Integrate_service | Register Plural Web Services in an |
| | integrated manner |
| Separate_service | Register respective Web Service |
| | separately |

Also, the registration unit 121 can register combination information of the integrated or separated methods in a combination information storage unit 121d. The combination information storage unit 121d can be referenced when the execution unit 123 executes each method included in a virtual web service generated by the generation unit 121c.

To determine the validity of the web services registered by the service provider 110, the determination unit 122 can determine whether a concerned web service is valid through the URL included in the WSDL of the concerned web service. For example, the determination unit 122 transmits a predetermined message through the URL of the WSDL on a predetermined web service, and then determines the validity of the concerned web service depending upon a response from the service provider 110 which provides the concerned web service, as the transmission result. In addition to the determination on the validity of the concerned web service, the determination unit 122 can also determine whether the corresponding web service is up-to-date through the response from the service provider 110, as stated above, even when it is in upgraded version.

Also, the APIs used when the determination unit 122 determines the validity and the version of the registered web services are identified in Table 4.

TABLE 4
API for Determining Version & Validity of Web Service

| | |
|---|---|
| Set_Schedule | Designate Schedule for Confirming |
| | Validity and Version |
| Get_Schedule | Confirm Schedule for Confirming |
| | Validity and Version |
| Stop | Stop Confirmation of Validity and Version of |
| | Web Service |
| Start | Start Confirmation of Validity and Version |
| | of |
| | Web Service |

The execution unit 123 functions to execute the web service requested by the service requester 130. When a virtual web service generated by the registration unit 121 is to be executed, the execution unit 123 can execute the virtual web service through the combination information stored in the combination information storage unit 121d.

Specifically, when the service requester 130 requests a virtual web service generated by integrating a plurality of methods, the execution unit 123 confirms the methods included in the virtual web service integrated by referencing the combination information storage unit 121d, and executes them. Meanwhile, when the service requester 130 requests virtual web services generated by separating a plurality of methods from each web service, the execution unit 130 confirms the methods included in the separate virtual web services created by the combination information storage unit 121d and executes them.

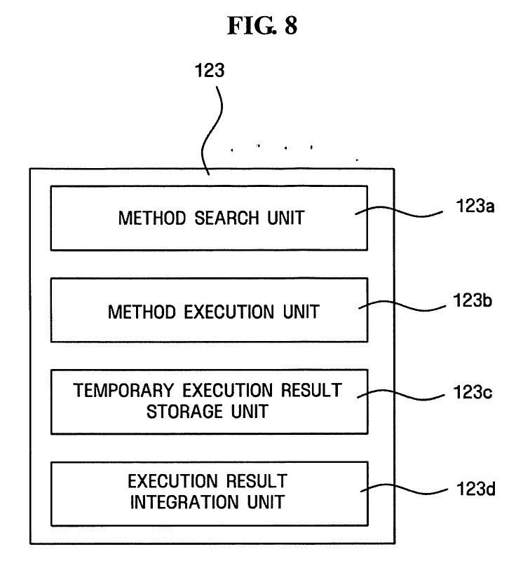

To execute respective methods included in the virtual web services, the execution unit 123 comprises a method search unit 123a (FIG. 8) that searches the methods included in a concerned virtual web service from the combination information storage unit 121d, a method execution unit 123b that executes each of the searched methods, a temporary execution result storage unit 123c that temporarily stores the execution result of each method, and an execution result integration unit 123d that integrates the temporarily stored results. The APIs used when the execution unit 120 executes the methods mentioned above are identified in Table 5.

TABLE 5
API for Executing Method

| | |
|---|---|
| Call_Method | Return Method Browse and Result |
| changeTransfer | Convert Transmission Protocol |
| changeNIC | Convert Network Device Used to Call Web |
| | Service |

The search unit 124 allows the service requester 130 to request WSDL information of a desired web service through the web service list stored in the storage unit 125 of the web service processing apparatus 120, and then requests the corresponding web service through the WSDL provided by the service provider 110 according to the request result. The search unit 124 can request the existing web service(s) provided by the service provider 110 and also virtual web service(s) created through integration or separation by the integration unit 121a and the separation unit 121b respectively.

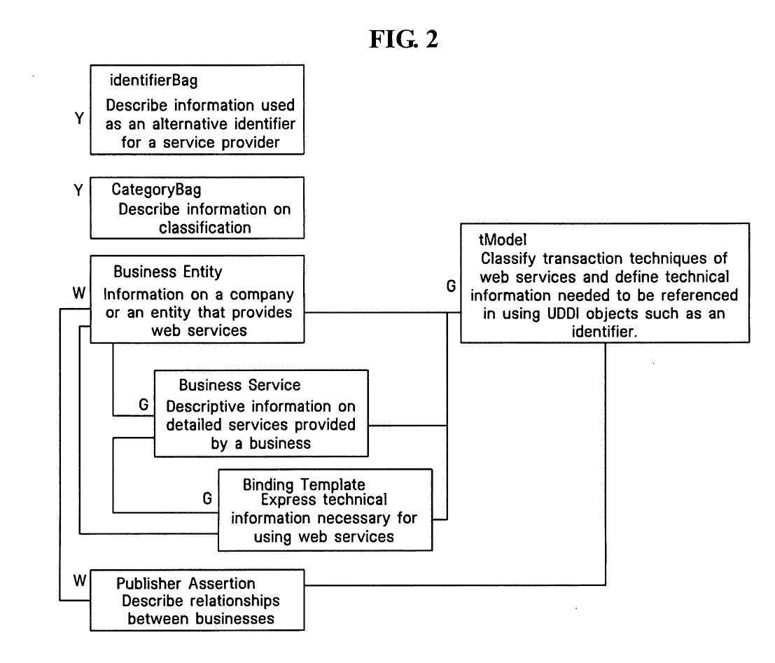

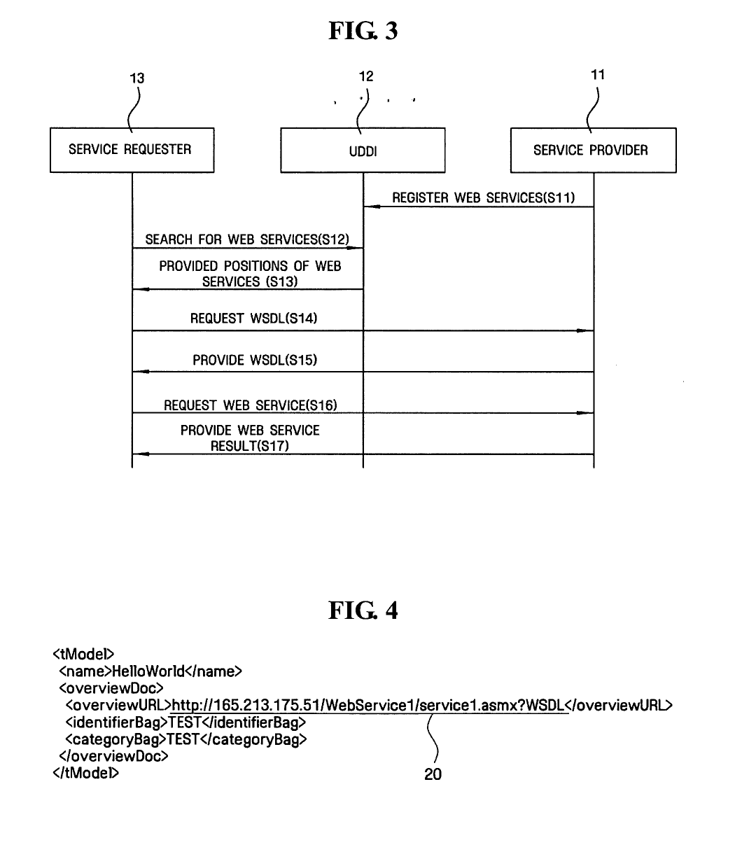

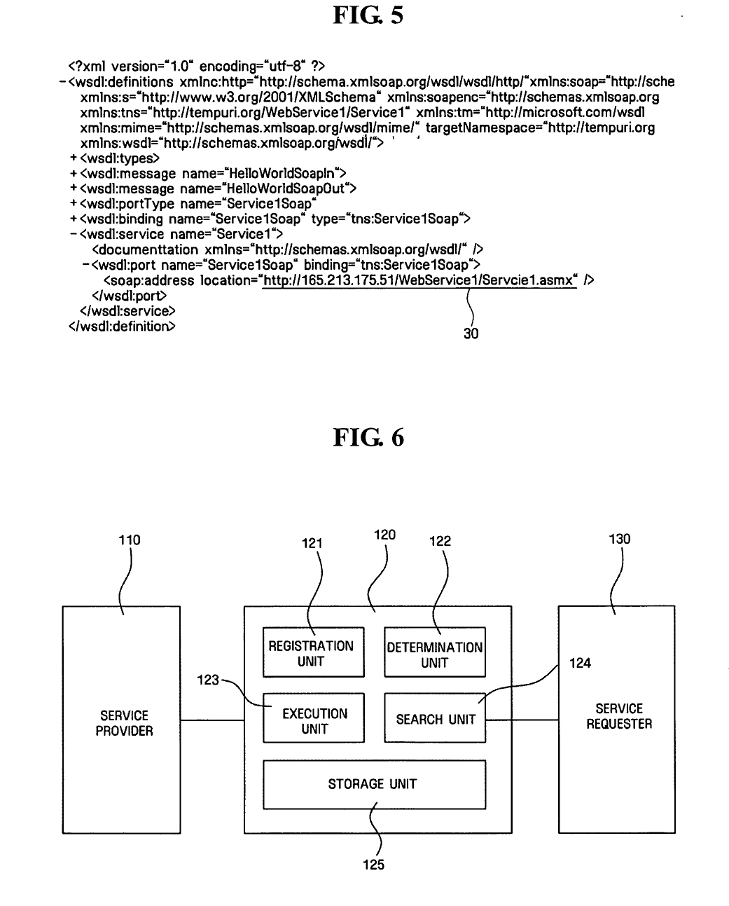

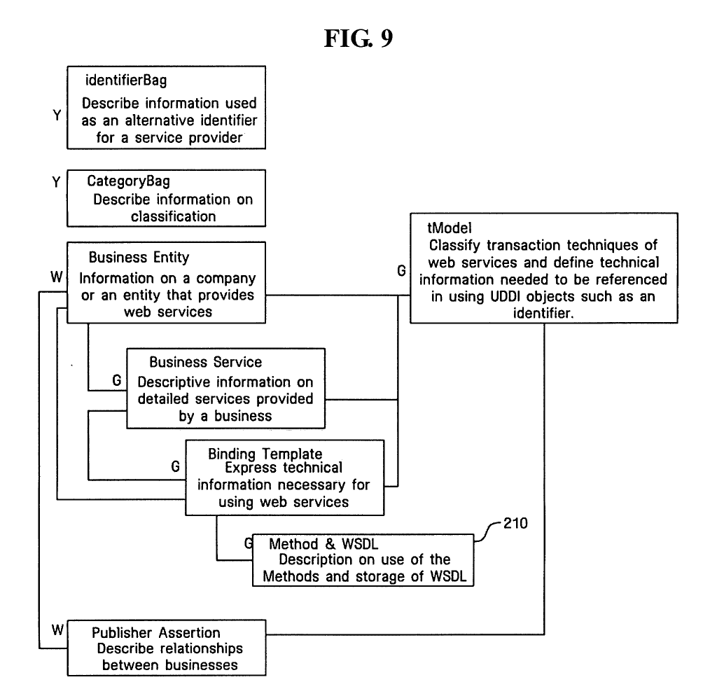

As illustrated in FIG. 9, Method & WSDL 210, which stores a description on the use of methods and WSDL, is added to the data structure of FIG. 2 described above. Accordingly, registration, search, execution and validity determination of the virtual web services created through integration or separation by the integration unit 121a or the separation unit 121b can be made through Method & WSDL. Method & WSDL of FIG. 9 is a green page G in the classification criterion of FIG. 2 described above.

Hereinafter, a web service processing method according to an exemplary embodiment of the present invention will be described in detail.

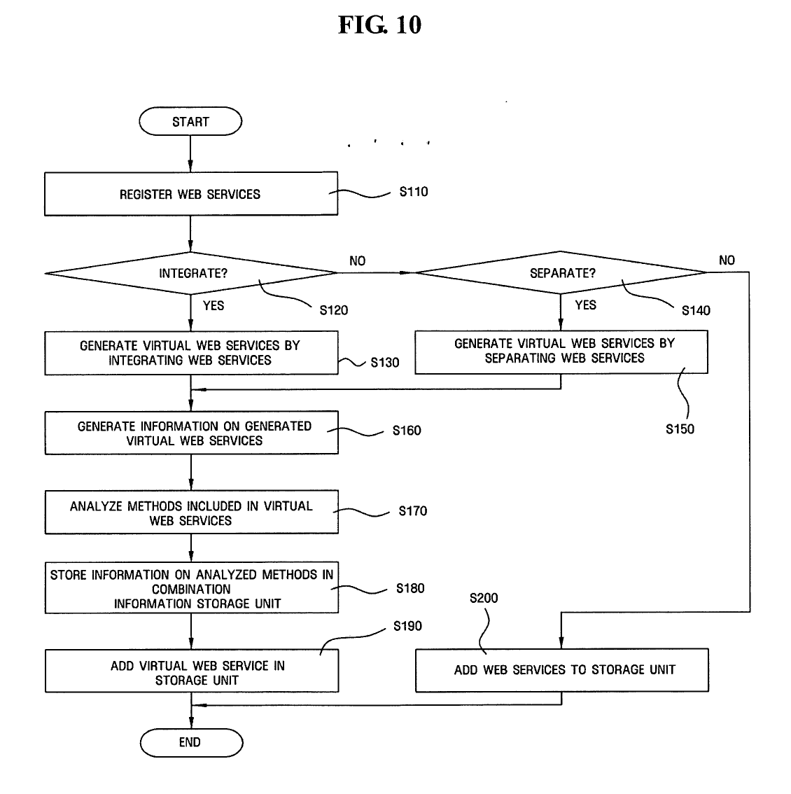

FIG. 10 illustrates a method for registering a web service according to an exemplary embodiment of the present invention.

As illustrated, the service provider registers a web service to be provided thereby through the registration unit 121 (S110). The registered web service can be integrated or separated according to a predetermined condition or a prior agreement between the service providers 110 who provide web services.

When the registered web services are integrated (S120), the registration unit 121 creates a virtual web service by integrating specific methods thorough the integration unit 121a (S130).

If the registered web services are separated (S140), the registration unit 121 creates virtual web services by separating specific methods through the separation unit 121b (S150).

The virtual web services for the integrated or separated methods can be created by the generation unit 121c. At the same time, the generation unit 121c generates information (for example, WSDL) on the generated virtual web service (S160). In this exemplary embodiment of the present invention, it has been described that a virtual web service and the information thereon are both generated in the generation unit 121c, but they may also be generated by another element.

The registration unit 121 analyzes the method included in the generated virtual web service (S170), and stores information on the analyzed method in the combination information storage unit 121d (S180). The web service information generated according to the generated virtual web service can be stored with the virtual web service in the combination information storage unit 121d.

Then, the registration unit 121 registers the generated virtual web service in the storage unit 125 (S190).

If the registered web services are not integrated or separated in step S120 or S140, the web service is registered in the storage unit 125 in a conventional manner (S200).

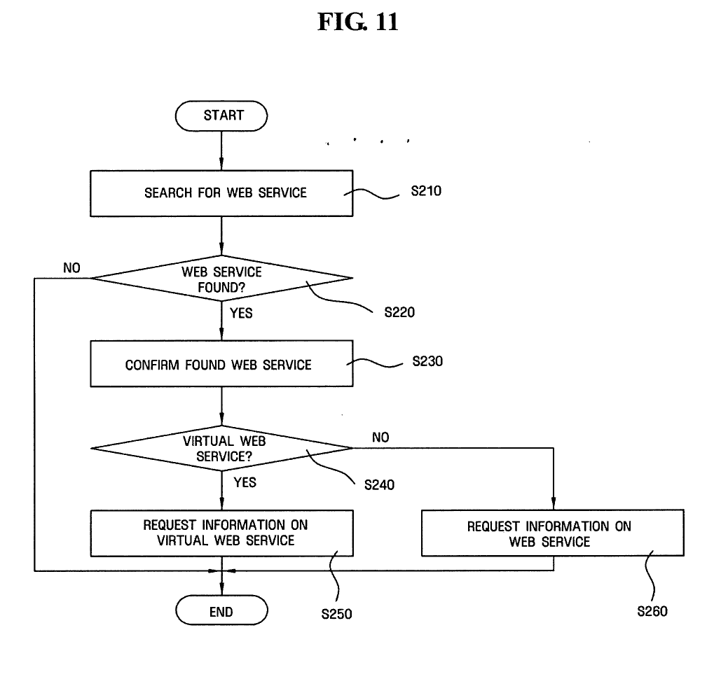

FIG. 11 illustrates a method whereby the service requester 130 searches the web services registered as illustrated in FIG. 10.

As illustrated, the service requester 130 searches for a desired web service by connecting to the web service processing apparatus 120 (S210).

If the desired web service is discovered as a result of the searching (S220), the search unit 124 confirms the discovered web service (S230). In other words, the discovered web service confirms whether it is existing or virtual.

When it is confirmed that the discovered web service is a virtual web service generated by the generation unit 121c (S240), the service requester 130 requests the virtual web service information generated according to the virtual web service (S250).

If the web service found in step S240 is an existing web service, the service requester 130 requests web service information of the corresponding web service (S260).

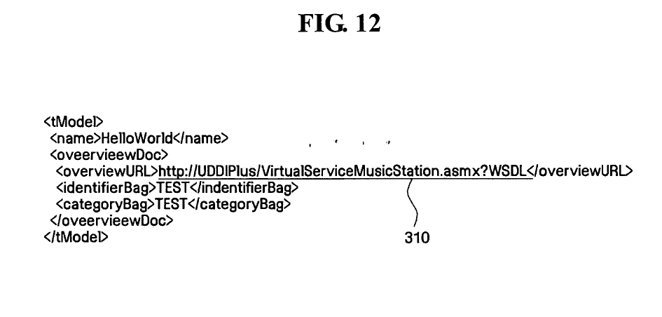

When information on the corresponding web service is requested as illustrated in FIG. 11, the web service processing apparatus 120 provides position information on the corresponding web service information (WSDL) from the web service lists stored in the storage unit 125. As illustrated in FIG. 12, the position information on the web service information may include a URL 310 for the corresponding web service information. Accordingly, the service requester 130 requests the corresponding web service information through the URL included in the position information of the provided web service information.

The request by the service requester 130 for the web service information is transmitted to the service provider 110, and the service provider 110 provides the web service information including the URL of the corresponding web service. Accordingly, the service requester 130 requests and executes the corresponding web service through the URL included in the provided web service information.

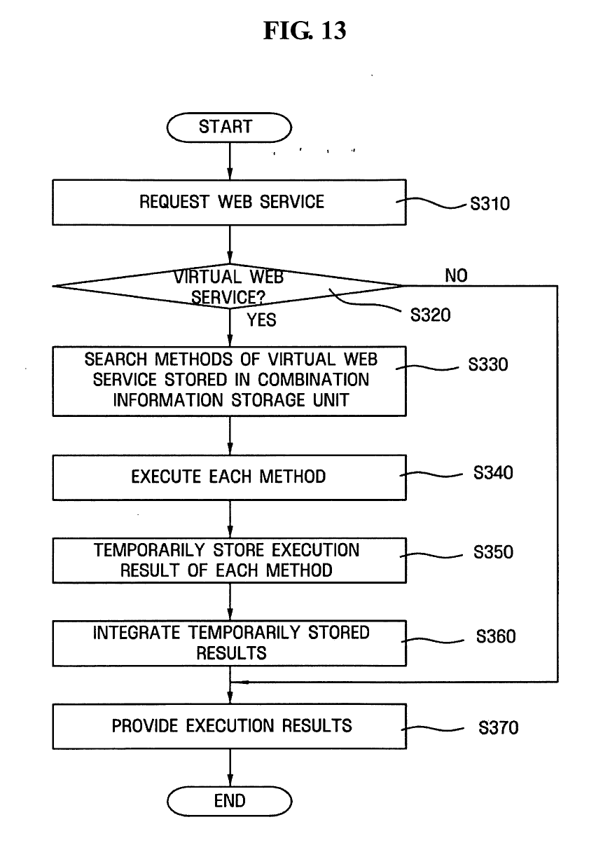

FIG. 13 illustrates a method of executing the searched web service according to the operations of FIG. 11.

As illustrated, the service requester 130 requests the searched for web service (S310), and the execution unit 123 determines whether the web service requested by the service requester 130 is a virtually generated web service (S320). As described above, the request for the web service can be made through the URL included in the web service information provided from the service provider 110.

As a result, when it is determined that the requested web service has been virtually generated by the generation unit 121c, the execution unit 123 searches for the methods included the corresponding virtual web service by referencing the combination information storage unit 121d.

The execution unit 123 executes each of the searched methods (S340) and stores the execution result in the temporary storage unit 123c (S350).

Then, the execution unit 123 integrates the execution result of the searched methods stored in the temporary storage unit 123c and provides the integrated execution result to the service requester 130 (S370).

When the web service searched in step S320 is an existing service, the execution unit 123 provides the execution result of the corresponding web service to the service requester 130.

The confirmation of the validity and the version of the web services registered in the web service processing apparatus 120 can be performed by the determination unit 122 at predetermined time intervals or periods through registration, search, and execution of the services illustrated in FIG. 10 and FIG. 11.

The validity and version confirmation can prevent invalid or lower version web services from being provided when the service requester 130 requests a web service, by deleting or modifying the invalid or lower version web services.

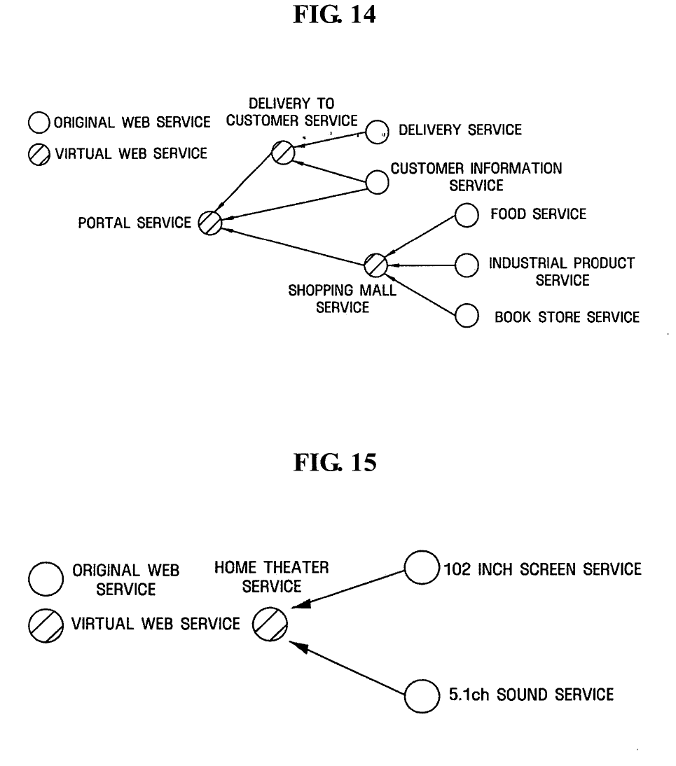

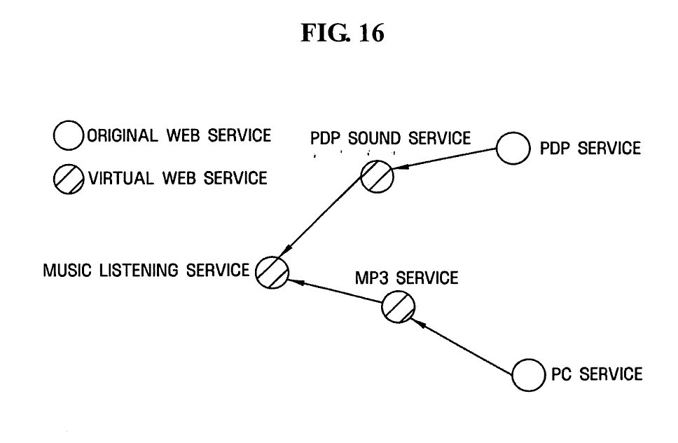

As illustrated in FIGS. 14 to 16, the web service processing apparatus and method provides new virtual web services by integrating respective services in a company or home network environment, and can be carefully used when providing new virtual web services by reintegrating the provided virtual web services.

As described above, according to the present invention, as a plurality of web services are integrated or separated to thereby generate virtual web services, different applications can be integrated even though each service has a different application. Accordingly, the service requester 130 can easily access web services.

The term “unit”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and to execute on one or more processors. Thus, a module may include, by way of example, components, such as software components, object-oriented software components, class components and task components, process, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The web service processing apparatus and method according to the present invention may produce at least one of the following effects.

First, more diverse web services can be provided through virtual web services generated by integrating or separating web services.

Second, the web services of different applications can be used together by integrating or separating web services.

Third, only valid web services will be provided by determining the validity of the web services.

While the present invention has been illustrated and described with respect to preferred embodiments thereof, it will be understood by those skilled in the art that the foregoing and other changes in form and details may be made therein without departing from the spirit and scope of the invention which should be limited only by the scope of the appended claims. Thus, exemplary embodiments of the invention disclosed above are used in a generic and descriptive sense only and not for purposes of limitation.

What is claimed is:

1. A web service processing apparatus comprising:
a registration unit by which a plurality of web services are integrated according to a predetermined combination condition and registered;
a storage unit that stores a list of the registered web services; and
an execution unit that executes a web service selected from the stored web service list by referencing to the combination conditions.

2. The apparatus of claim 1, wherein the registration unit comprises:
an integration unit that integrates the plurality of web services;
a separation unit that separates the plurality of web services;
a generation unit that generates virtual web services with respect to the integrated or separated web services; and
a combination information storage unit that stores combination information of the integrated or separated web services.

3. The apparatus of claim 2, wherein the integration unit integrates at least one method among the methods included in the plurality of web services.

4. The apparatus of claim 2, wherein the separation unit separates at least one method included in the plurality of web services.

5. The apparatus of claim 2, wherein the combination information storage unit stores information on each method included in the virtual web services generated through integration or separation.

6. The apparatus of claim 5, wherein the execution unit comprises:
a method search unit that searches for methods included in the corresponding web service through combination information with respect to the selected web service;
a method execution unit that executes each of the searched methods;
a temporary execution result storage unit that temporarily stores the execution result of each method; and
an execution result integration unit that integrates the temporarily stored result.

7. The apparatus of claim 1, further comprising a determination unit that determines the validity or version of a web service corresponding to the web service lists stored in the storage unit.

8. The apparatus of claim 7, wherein the determination unit transmits a predetermined message with a URL of the corresponding web service, and determines the validity and version of the corresponding web service according to a response to the transmitted message.

9. A web service processing method comprising:
combining a plurality of web services through predetermined combination conditions;
storing a list of the combined web services; and
executing a web service selected from the stored web service lists by referencing the combination condition.

10. The method of claim 9, wherein the combining comprises generating virtual web services combined through the combination conditions.

11. The method of claim 10, wherein the virtual web services are formed by integrating at least one method included in the plurality of web services.

12. The method of claim 10, wherein the virtual web services are generated by separating at least one method included in the plural web services.

13. The method of claim 10, wherein the combining comprises storing information for each method included in the generated virtual web service.

14. The method of claim 9, wherein the executing of the web services comprises:
searching for information on each method included in a web service selected from the web service lists;
executing the methods according to the information on each of the searched methods;
temporarily storing each execution result of the executed methods; and
integrating the temporarily stored execution results.

15. The method of claim 9 further comprising determining the validity or version of the web service of the web service lists.

16. The method of claim 15, wherein the determination of validity or version comprises transmitting a predetermined message to a URL of the corresponding web service, and determining the validity or version of the corresponding web service according to a response to the transmitted message.
